(19) United States
(12) Patent Application Publication
(10) Pub. No.: US 2023/0371665 A1
(43) Pub. Date: Nov. 23, 2023

(54) POWER SUPPLY CONTROL STRUCTURE OF UMBRELLA

(71) Applicant: Xiamen Mingho Brothers MFG Co., Ltd, Fujian (CN)

(72) Inventors: Sun Jung CHEN, Fujian (CN); Sun Feng Sung, Fujian (CN); Ming Hsiung Chen, Fujian (CN)

(21) Appl. No.: 18/226,827

(22) Filed: Jul. 27, 2023

Related U.S. Application Data
(63) Continuation of application No. PCT/CN22/93504, filed on May 18, 2022.

(51) Int. Cl. A45B 25/10; H02J 7/00; A45B 25/08

(52) U.S. Cl. CPC A45B 25/10; H02J 7/0063; A45B 25/08; A45B 2200/1018

(57) ABSTRACT

A power supply control structure of an umbrella, having an umbrella body and a power supply device, the umbrella body has a shaft, a notch at the upper end of the shaft, a runner movably sleeving the shaft, and a rib assembly hinged with the notch and the runner; the power supply device is positioned on an upper part of the umbrella body. Accordingly, a conductive connecting piece for connecting the power supply device and an electronic device on the upper part of the umbrella body is minimally limited by the shaft so that installation position of the conductive connecting piece can be simpler and more convenient.

### BACKGROUND OF THE INVENTION

The present invention relates to the field of umbrellas, and in particular to a power supply control structure of an umbrella.

According to the existing umbrella, an electronic device (such as an illuminating lamp, or a radio) is arranged on an umbrella body, so that the functions of the umbrella are enriched, and the selling points of the umbrella are increased; the electronic device is generally arranged on the upper part of the umbrella (such as an umbrella canopy cloth, a notch, a rib assembly or an upper part of a shaft) to ensure a good use effect. The power required to operate the electronic device is from a power supply device, the power supply device is generally arranged in an umbrella handle at the lower part of the umbrella body, thus a conductive connecting piece (such as a lead) for connecting the power supply device and the electronic device is required to be arranged on the shaft of the umbrella body, and in order not to interfere with the movement of a runner, the conductive connecting piece is required to run inside the shaft and has a long length inside the shaft, and the conductive connecting piece is therefore greatly limited by the shaft, which makes it troublesome to mount the conductive connecting piece, and this kind of arrangement is only suitable for non-collapsible umbrella and hence has limitation.

### BRIEF SUMMARY OF THE INVENTION

The present invention aims to provide a power supply control structure of an umbrella, which can enable a conductive connecting piece to be minimally limited by a shaft so that the arrangement of the conductive connecting piece can be simpler and more convenient.

In order to achieve the above objectives, the present invention adopts the following solutions:

A power supply control structure of an umbrella, which comprises an umbrella body and a power supply device for supplying power, wherein the umbrella body comprises a shaft, a notch arranged at an upper end of the shaft, a runner movably sleeving the shaft, and a rib assembly hinged to the notch and the runner; the power supply device is arranged on an upper part of the umbrella body; the power supply device comprises a power supply battery.

The power supply device is mounted in the notch; or the power supply device is mounted on the rib assembly; or the power supply device is mounted on an upper part of the shaft and above the runner.

The power supply device is provided with a control switch configured to control whether the power supply device provides external power supply or not.

The runner controls whether the control switch is on or off.

The control switch is an inductive switch, and the runner is provided with an inductive piece configured to control whether the inductive switch is on or off.

The control switch is a tactile switch, and the runner presses against the tactile switch or released from pressing the tactile switch to control whether the tactile switch is on or off.

The power supply control structure further comprises a trigger piece, wherein the trigger piece is movably mounted in the runner and movable up and down and be positioned relative to the runner; the trigger piece turns on the control switch when a distance between the trigger piece and the control switch reaches a trigger distance, thereby controlling the power supply device to provide external power supply.

The runner is provided with two oppositely arranged through holes, and the shaft is provided with two buckling holes corresponding to the through holes of the runner respectively: the runner is also fitted with a buckling component for buckling with the shaft of the umbrella body; the buckling component comprises two oppositely arranged buckling pieces which are provided with buckling blocks respectively, the buckling blocks of the two buckling pieces pass through the two through holes of the runner respectively towards a center of the runner, and removably buckle with the two buckling holes of the shaft respectively; the runner is fitted with a sliding sleeve skiable up and down on the runner and being positioned relatively to the runner; the sliding sleeve partially sleeves the runner and entirely sleeves the two buckling pieces; an inner wall of the sliding sleeve is also provided with a pushing part configured to drive the two buckling pieces to move towards a direction away from the center of the runner; the trigger piece is mounted in the runner.

The control switch is a magnetic inductive switch, and the trigger piece is a magnetic element.

The control switch is a tactile switch, and the trigger piece is configured to press a key of the control switch or released from pressing the key of the control switch.

The control switch is a remote control switch, and the remote control switch is controlled by a remote controller.

The control switch is a tactile switch or a self-locking switch.

Beneficial effects of the present invention:

According to the above technical solutions of the present invention, the power supply device is arranged on the upper part of the umbrella body, so that the length of the conductive connecting piece (which is used for connecting the power supply device and the electronic device arranged on the upper part of the umbrella body) running inside the shaft can be shortened, and even the conductive connecting piece does not need to pass through the shaft, which can enable the conductive connecting piece to be minimally limited by the shaft, and even not limited by the shaft, so that the arrangement of the conductive connecting piece can be simpler and more convenient. The present invention enables the conductive connecting piece to be minimally limited by the shaft, so that no matter the umbrella body of the present invention is a folding umbrella or a non-collapsible umbrella, the present invention can ensure that the power supply device can supply power to the electronic device arranged on the upper part of the umbrella body through the conductive connecting piece without interfering with the normal folding/unfolding and extending/retracting of the umbrella body, and hence the scope of application is wider.

### BRIEF DESCRIPTION OF THE DRAWINGS

FIG. 1 is a schematic structural diagram (an umbrella body is in an open state) of Embodiment 1 of the present invention;

FIG. 2 is a schematic structural diagram 2 (the umbrella body is in a closed state) of Embodiment 1 of the present invention;

FIG. 3 is a partial cross-sectional view (the umbrella body is in an open state) of Embodiment 1 of the present invention;

FIG. 4 is a schematic structural diagram (an umbrella body is in an open state) of Embodiment 2 of the present invention;

FIG. 5 is a schematic structural diagram 2 (an umbrella body is in a closed state) of Embodiment 2 of the present invention;

FIG. 6 is a partial cross-sectional view (the umbrella body is in an open state) of Embodiment 2 of the present invention;

FIG. 7 is a schematic structural diagram(an umbrella body is in an open state) of Embodiment 3 of the present invention;

FIG. 8 is a schematic structural diagram 2 (an umbrella body is in a closed state) of Embodiment 3 of the present invention;

FIG. 9 is a schematic structural diagram 1 (an umbrella body is in an open state) of Embodiment 4 of the present invention;

FIG. 10 is a schematic structural diagram 2 (an umbrella body is in a closed state) of Embodiment 4 of the present invention;

FIG. 11 is a schematic structural diagram 1 (an umbrella body is in an open state, and a trigger piece triggers a control switch) of Embodiment 5 of the present invention;

FIG. 12 is a schematic structural diagram 2 (an umbrella body is in an open state, and the trigger piece does not trigger the control switch) of Embodiment 5 of the present invention;

FIG. 13 is a schematic structural diagram 3 (an umbrella body is in a closed state, and the trigger piece does not trigger the control switch) of Embodiment 5 of the present invention;

FIG. 14 is a partial cross-sectional view 1 of Embodiment 5 of the present invention (an umbrella body is in an open state, and the positioning buckle is buckled to a lower positioning strip, and the trigger piece triggers the control switch);

FIG. 15 is a partial cross-sectional view 2 of Embodiment 5 of the present invention, wherein FIG. 15 shows the same state of the umbrella body as shown in FIG. 14, but only in a different sectional plane;

FIG. 16 is a partial cross-sectional view 3 of Embodiment 5 of the present invention (an umbrella body is in an open state, and the positioning buckle is buckled to an upper positioning strip, and the trigger piece does not trigger the control switch);

FIG. 17 is a partial cross-sectional view 4 of Embodiment 5 of the present invention, wherein FIG. 17 shows the same state of the umbrella body as shown in FIG. 16, but only in a different sectional plane;

FIG. 18 is a partial cross-sectional view 5 of Embodiment 5 of the present invention (an umbrella body is in a state when it is ready to enter a closed state, wherein the positioning buckle is buckled to a blocking portion, and the runner is ready to move downwardly upon driving by the sliding sleeve);

FIG. 19 is a partial cross-sectional view 6 of Embodiment 5 of the present invention, wherein FIG. 19 shows the same state of the umbrella body as shown in FIG. 18, but only in a different sectional plane;

FIG. 20 is a partial cross-sectional view 7 of Embodiment 5 of the present invention (an umbrella body is in a closed state, wherein the runner is driven to move downwardly by the sliding sleeve);

FIG. 21 is a partial cross-sectional view 8 of Embodiment 5 of the present invention, wherein FIG. 21 shows the same state of the umbrella body as shown in FIG. 20, but only in a different sectional plane;

FIG. 22 is a partial cross-sectional view 9 of Embodiment 5 of the present invention, showing the umbrella body in the open state shown in FIGS. 14-17, but in a different sectional plane;

FIG. 23 is an exploded view of partial structure of Embodiment 5 of the present invention; and

FIG. 24 is a schematic structural diagram of a sliding sleeve of Embodiment 5 of the present invention.

### DESCRIPTION OF REFERENCE NUMERALS

an umbrella body 1,
a shaft 11,
a notch 12,
a runner 13, an inductive piece 131, a deformable part 132, an elastic sheet 1320, a positioning buckle 1321, a through hole 133, a limiting part 134, a slot 135,
a rib assembly 14,
a top cap 15,
an umbrella canopy cloth 16,
an umbrella handle 17,
a sliding sleeve 18, a positioning partial, a positioning strip 1811 a pushing part 182, a pushing block 1821, a pushing inclined surface 1822, blocking portion 183
a buckling component buckling piece 191, a buckling block 191 1, an inclined surface 1912,
a power supply device 2, a power supply battery 21, a control switch 22, a power supply seat 23,
an electronic device 3,
a remote controller 4, and
a trigger piece 5.

### DETAILED DESCRIPTION OF THE INVENTION

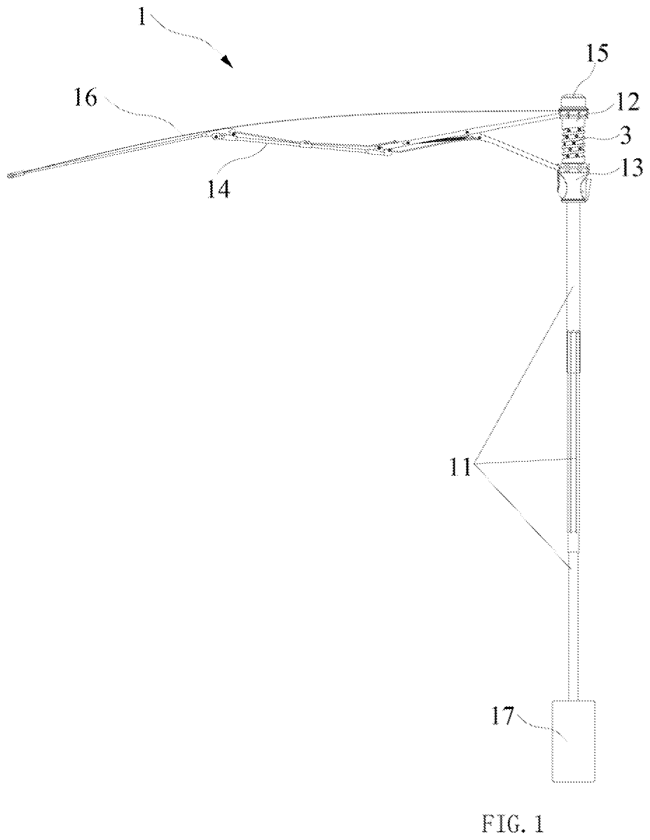

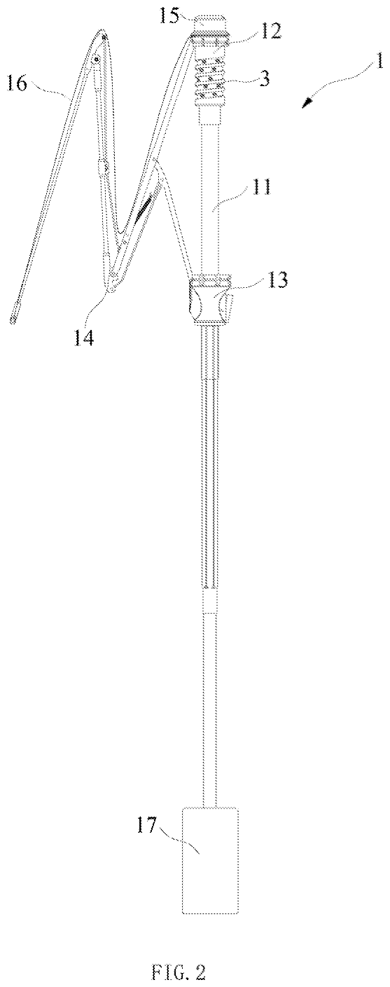

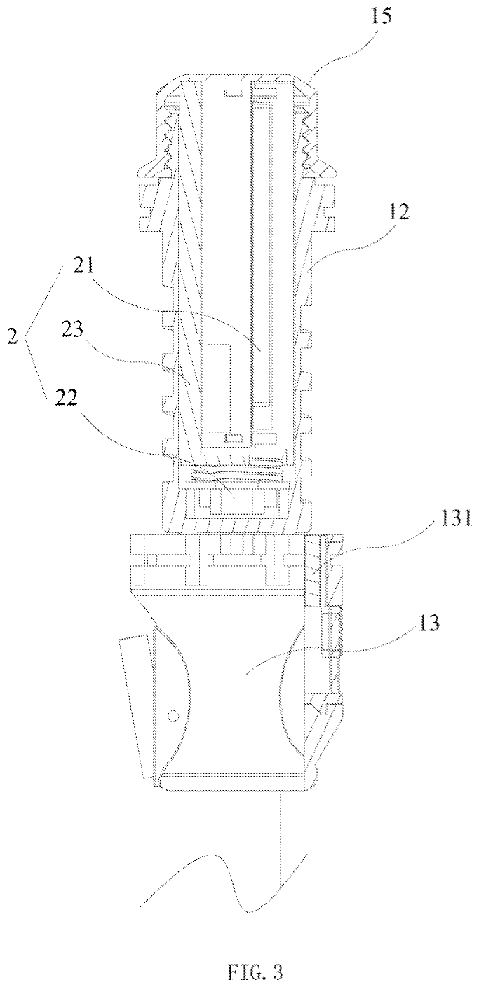

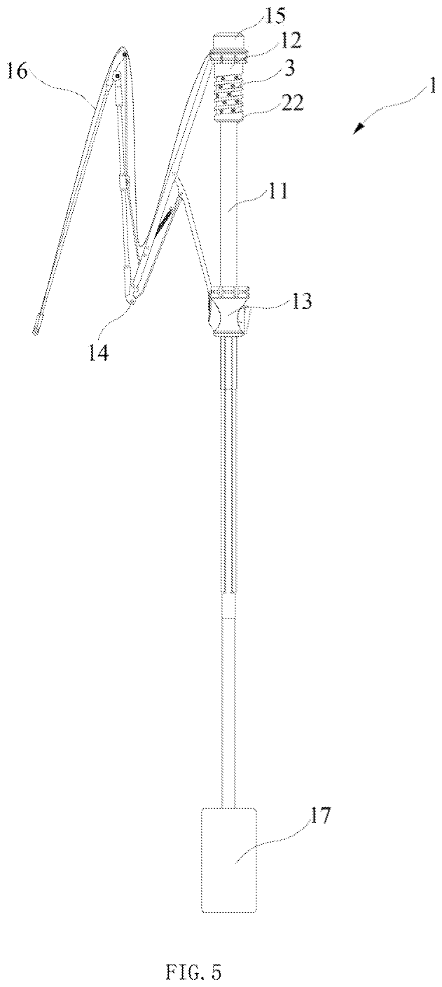

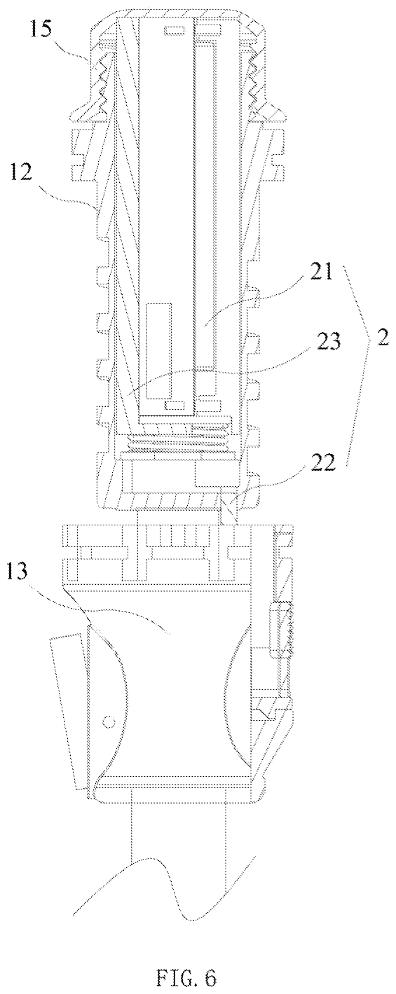

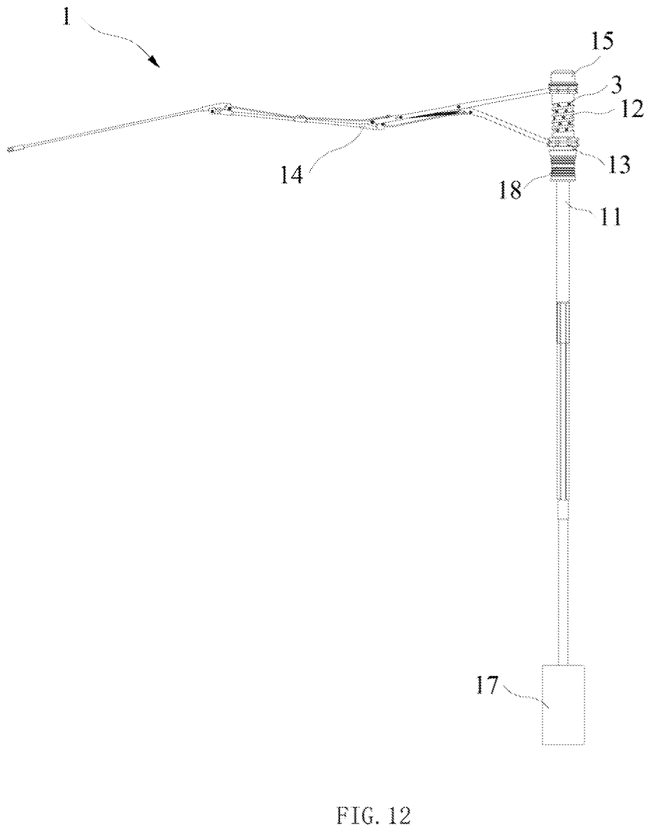

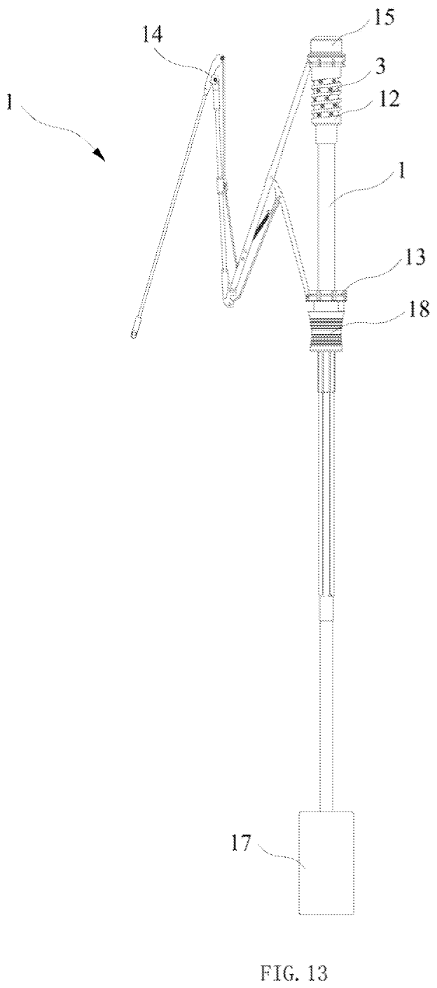

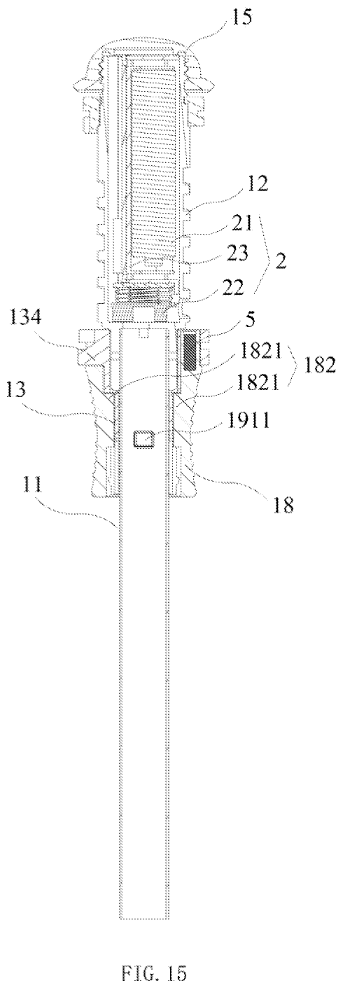

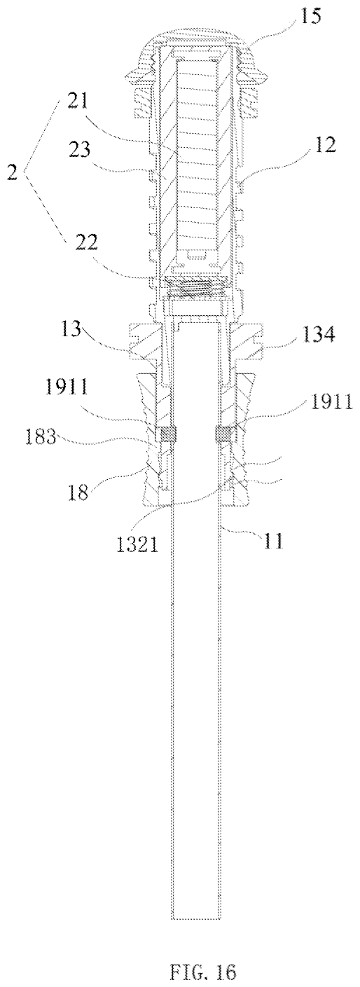

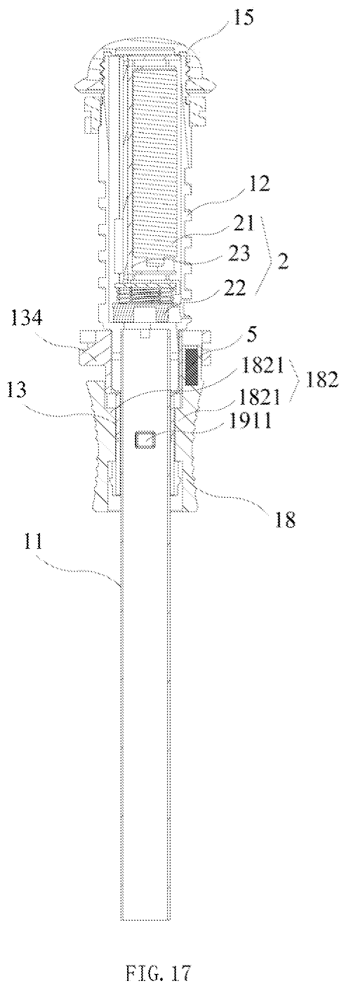

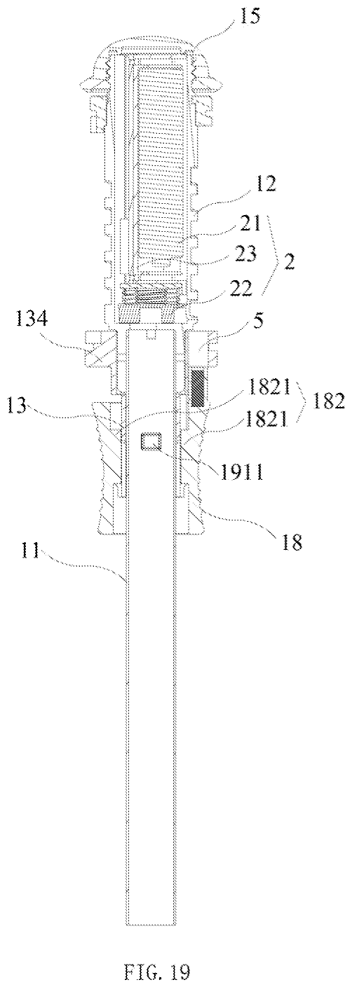

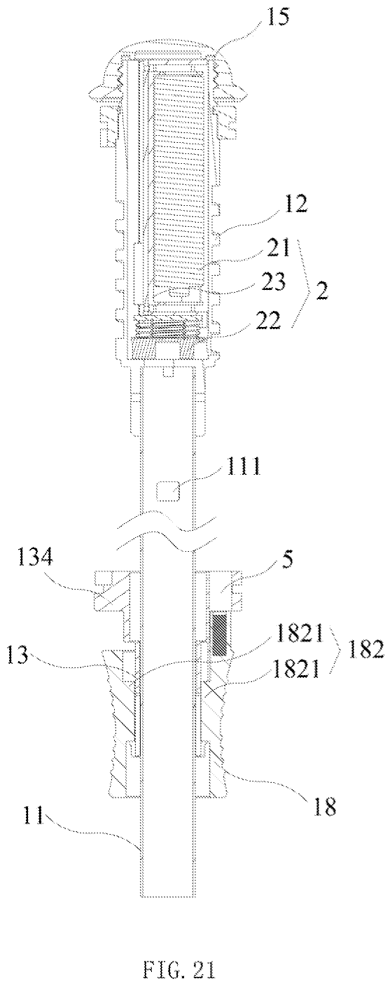

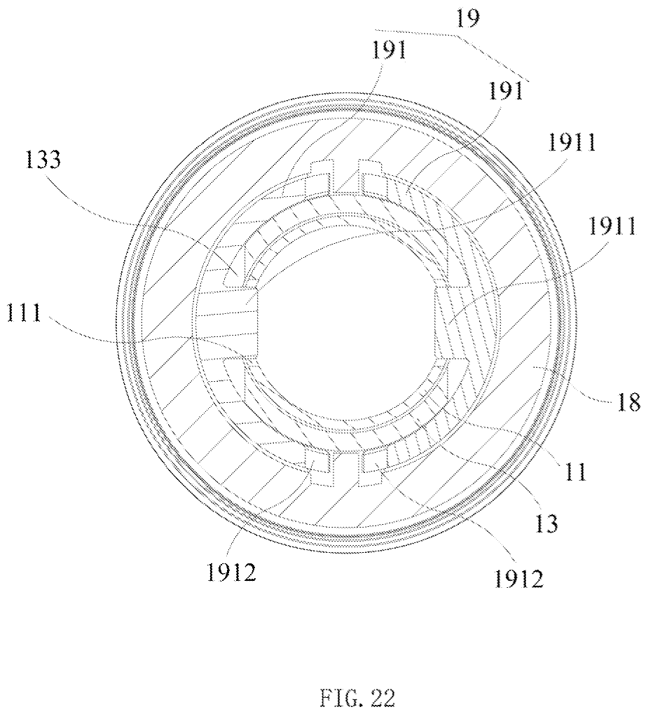

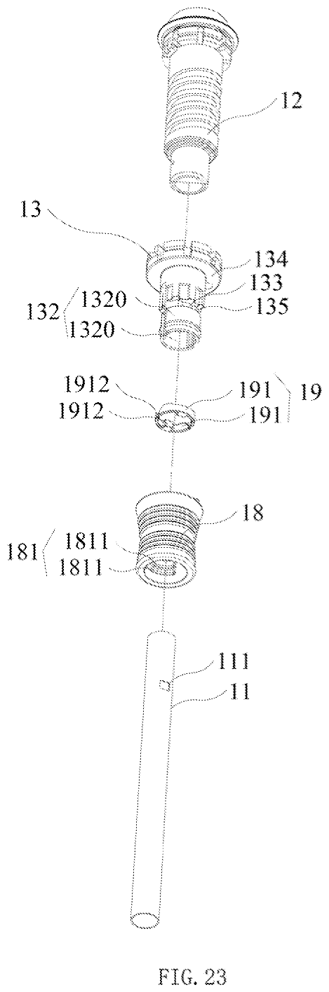

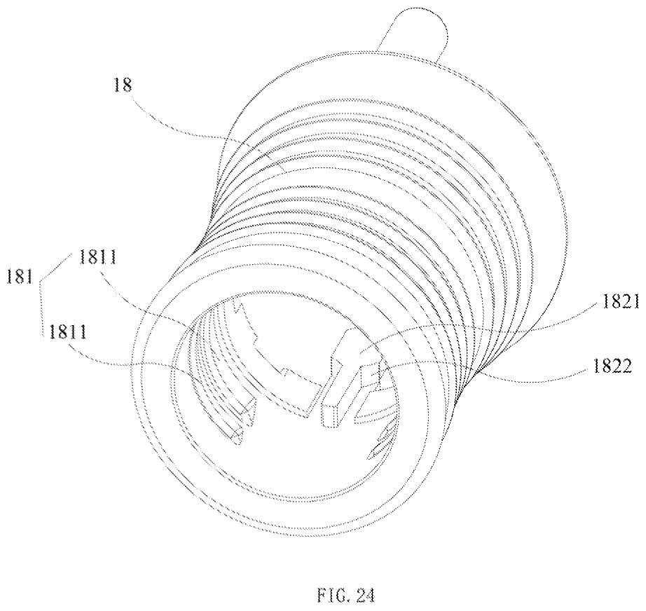

As shown in FIGS. 1 to 24, the present invention discloses a power supply control structure of an umbrella, which comprises an umbrella body 1 and a power supply device 2 for supplying power, wherein the umbrella body 1 comprises a shaft 11, a notch 12 arranged at an upper end of the shaft 11, a runner 13 movably sleeving the shaft 11, and a rib assembly 14 hinged to the notch 12 and the runner 13; the power supply device 2 is arranged on an upper part of the umbrella body 1, the power supply device 2 comprises a power supply battery 21 that supplies power.

According to the present invention, the power supply device 2 is arranged on the upper part of the umbrella body 1 s so that a length of a conductive connecting piece (which is used for connecting the power supply device 2 and an electronic device 3 arranged on the upper part of the umbrella body 1) running inside the shaft 11 can be shortened, and even the conductive connecting piece does not need to be disposed inside the shaft 11, which can enable the conductive connecting piece to be minimally limited by the shaft 11, and even not limited by the shaft 11, so that the arrangement of the conductive connecting piece can be simpler and more convenient. The present invention enables the conductive connecting piece to be minimally limited by the shaft 11, so that no matter the umbrella body 1 of the present invention is a folding umbrella or a non-collapsible umbrella, the present invention can ensures that the power supply device 2 can supply power to the electronic device 3 arranged on the upper part of the umbrella body 1 through the conductive connecting piece without interfering with the normal folding/unfolding and extending/retracting of the umbrella body 1, and thus the application of the present invention is wider.

In order to further explain the technical solutions of the present invention, the present invention will be explained in detail by the specific embodiments.

### Embodiment 1

With reference to FIGS. 1 to 3, in Embodiment 1 of the present invention, the umbrella body 1 is a folding umbrella; the power supply device 2 is mounted in the notch 12 such that the power supply device 2 is arranged on the upper part of the umbrella body 1.

Specifically, in Embodiment 1 of the present invention, the power supply device 2 is mounted in the notch 12 to protect the power supply device 2 through the notch 12; the notch 12 can be arranged with a top opening, the top opening of the notch 12 is covered by a top cap 15, and the top cap 15 is detachably connected with the notch 12, so that people can access an interior of the notch 12 through the top opening of the notch 12 to replace the power supply battery 21 of the power supply device 2, which is convenient for users to use; in addition, users can open top cap 15 and expose the top opening of the notch 12 without being interfered by the rib assembly 14 and the runner 13. The top cap 15 can be threadedly connected with the notch 12, so that the top cap 15 and the notch 12 are convenient to disassemble and assemble. It should be noted that the power supply device 2 can also be mounted on top of the notch 12, which is also convenient for users to operate the power supply device 2.

In Embodiment 1 of the present invention, the umbrella body 1 can further comprise an umbrella canopy cloth 16 covering on the rib assembly 14, wherein an inner edge of the umbrella canopy cloth 16 is clamped between the top cap 15 and the notch 12, so that the top cap 15 can also fix the umbrella canopy cloth 16.

In Embodiment 1 of the present invention, the power supply device 2 is provided with a control switch 22 for controlling whether the power supply device 2 provides external power supply or not, so that a user can control whether the power supply device 2 provides external power supply or not through the control switch 22, and hence control whether the electronic device 3 that receives power from the power supply device 2 operates or not. The power supply battery 21 can be mounted on a power supply seat 23, the power supply seat 23 is then mounted in the notch 12, and the control switch 22 is fixed on the notch 12 and electrically connected with the power supply battery 21 through contact connection.

In Embodiment 1 of the present invention, the control switch 22 can be controlled by the runner 13, so that when the umbrella body 1 is switched from a closed state to an open state, the control switch 22 automatically controls the power supply device 2 to provide external power supply; and when the umbrella body 1 is switched from an open state to a closed state, the control switch 22 automatically controls the power supply device 2 to stop providing external power supply, which is therefore convenient for people to use. The control switch 22 can be an inductive switch, and the runner 13 is provided with an inductive piece 131 for controlling whether the inductive switch is on or off. When the umbrella body 1 is switched from a dosed state to an open state, the inductive switch is induced by the inductive piece and therefore controls the power supply device 2 to provide external power supply; when the umbrella body 1 is switched from the open state to the dosed state, the inductive switch is not induced by the inductive piece and therefore controls the power supply device 2 to stop providing external power supply; the inductive switch controlling whether the power supply device 2 provides external power supply is a conventional technology, and is not described herein again. The control switch 22 can be a magnetic inductive switch (such as a reed switch), and the inductive piece 131 is correspondingly a magnetic element (such as a permanent magnet); there is no doubt that the control switch 22 can also be selected from other types of inductive switch, as long as the control switch 22 can be induced by the inductive piece 131 and is controlled by the inductive piece 131.

In Embodiment 1 of the present invention, the electronic device 3 can be an illuminating lamp to provide illumination and alert functions, wherein the illuminating lamp can be specifically mounted on an outer side of the notch 12, and a conductive connecting piece connecting the illuminating lamp and the power supply device 3 passes through the notch 12, so that the conductive connecting piece does not need to pass through the shaft 11. It should be noted that the electronic device 3 can also be a radio or a Bluetooth speaker, etc.

### Embodiment 2

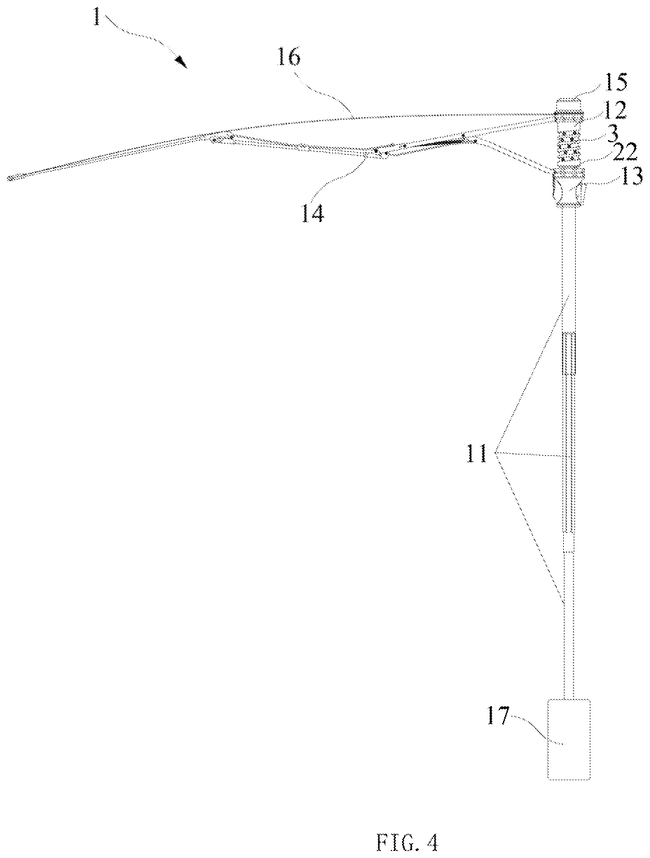

With reference to FIGS. 4 to 6, the difference between Embodiment 1 and embodiment 2 mainly lies in the control switch 22. In Embodiment 2 of the present invention, the control switch 22 is a tactile switch, and the runner 13 may press against the tactile switch or released therefrom to control whether the tactile switch is on or off, thereby controlling whether the power supply device 2 provides external power supply or not, so that when the umbrella body 1 is switched from a closed state to an open state, the control switch 22 automatically controls the power supply device 2 to provide external power supply; and when the umbrella body 1 is switched from an open state to a closed state, the control switch 22 automatically controls the power supply device 2 to stop providing external power supply.

### Embodiment 3

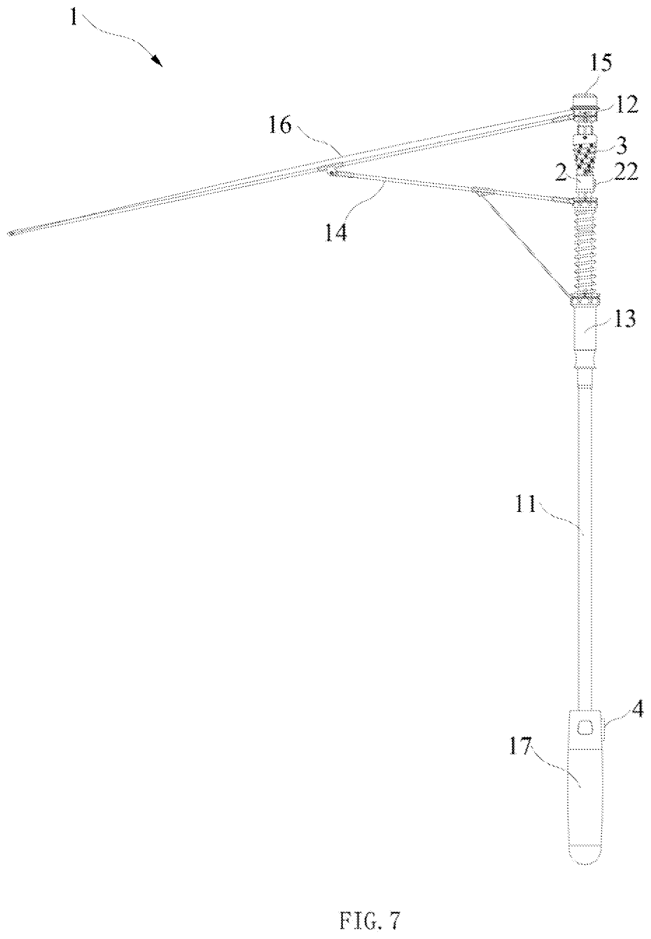

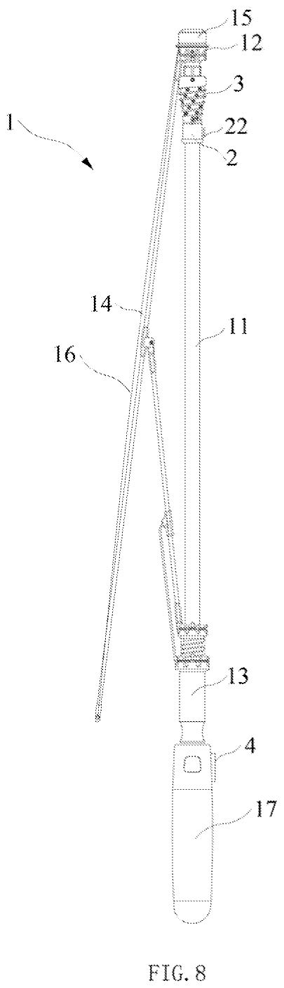

With reference to FIGS. 7 and 8, in Embodiment 3 of the present invention, the umbrella body 1 is a non-collapsible umbrella: the power supply device 2 is mounted on an upper part of the shaft 11 such that the power supply device 2 is arranged on an upper part of the umbrella body 1, and the power supply device 2 can be located above the runner 13 to prevent the power supply device 2 from affecting the movement of the runner 13. The power supply device 2 can be fixed on an outer side of the upper part of the shaft 11, and can also be fixed on an inner side of the upper part of the shaft 11.

In Embodiment 3 of the present invention, the power supply device 2 is also provided with a control switch 22 for controlling whether the power supply device 2 provides external power supply or not; the control switch 22 can be a remote control switch controlled by a remote controller 4, and the remote control switch can be an infrared remote control switch, a microwave remote control switch or a Bluetooth remote control switch; the umbrella body 1 can also comprise an umbrella handle 17 arranged at a lower end of the shaft 11, and the remote controller 4 is mounted on the umbrella handle 17 so that it is convenient for user to operate the remote controller 4; the remote control switch controlling whether the power supply device 2 provides external power supply is a conventional technology, and is not described herein again.

### Embodiment 4

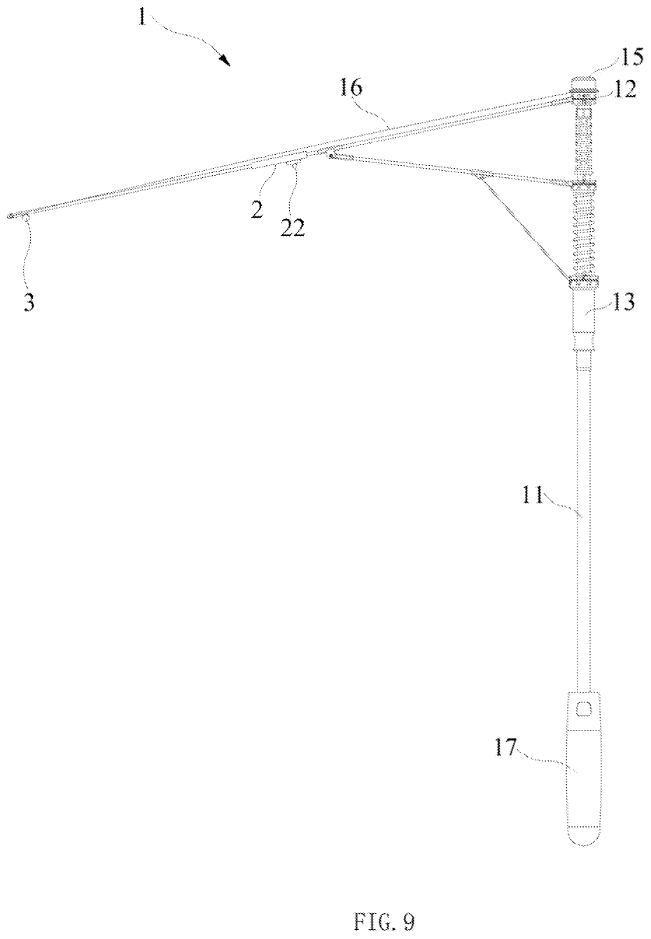

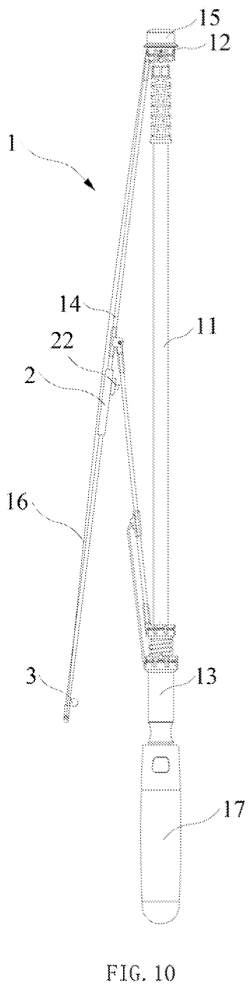

With reference to FIGS. 9 and 10, in Embodiment 4 of the present invention, the umbrella body 1 is a non-collapsible umbrella; the power supply device 2 is mounted on the rib assembly 14 so that the power supply device 2 is arranged on the upper part of the umbrella body 1; in Embodiment 4 of the present invention, the power supply device 2 is arranged on the rib assembly 14, and this arrangement is more suitable for a structure in which the electronic device 3 is mounted on the rib assembly 14 or the umbrella canopy cloth 16.

In Embodiment 4 of the present invention, the power supply device 2 is also provided with a control switch 22 for controlling whether the power supply device 2 provides external power supply or not, wherein the control switch 22 can be directly operated and controlled by hand of the user. Specifically, the control switch 22 may be a tactile switch or a self-locking switch. The tactile switch or the self-locking switch controlling whether the power supply device 2 provides external power supply or not is a conventional technology, and is not described herein again, It should be noted that the power supply device 2 is disposed on the rib assembly 14, which is convenient for user to operate the control switch 22 of the power supply device 2.

### Embodiment 5

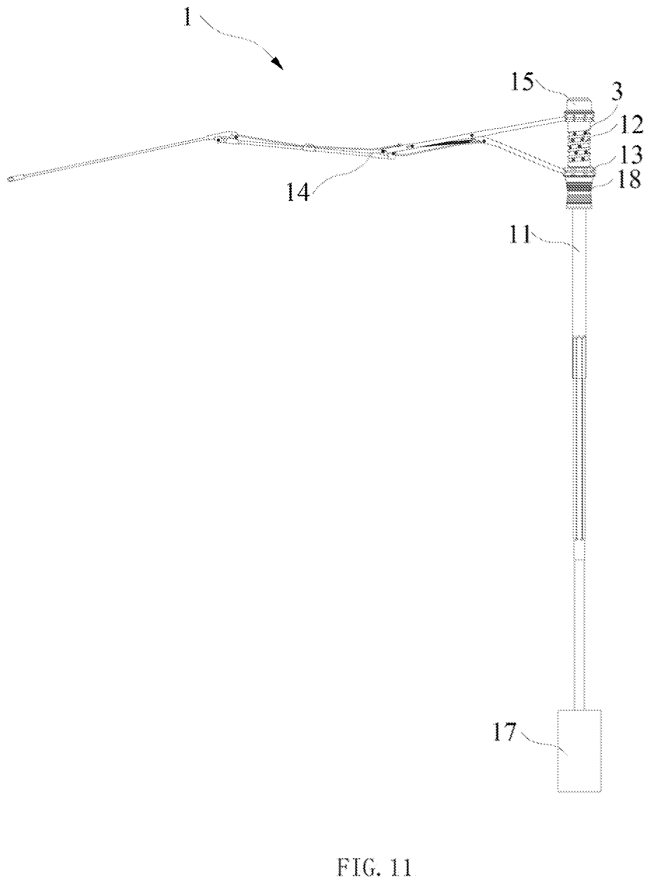

With reference to FIGS. 11 to 24, in Embodiment 5 of the present invention, the umbrella body 1 is a folding umbrella; the power supply device 2 is mounted in the notch 12 such that the power supply device 2 is arranged on the upper part of the umbrella body 1.

Specifically, in Embodiment 5 of the present invention, the power supply device 2 is mounted inside the notch 12 to protect the power supply device 2 through the notch 12; the notch 12 can be arranged with a top opening, the top opening of the notch 12 is covered by a top cap 15, and the top cap 15 is detachably connected with the notch 12, so that user can open the top cap and access an interior of the notch 12 through the top opening of the notch 12 to replace a power supply battery 21 of the power supply device 2, which is convenient for users to use; in addition, users can access the interior of the notch 12 through the top opening of the notch 12 without being interfered by the rib assembly 14 and the runner 13. The top cap 15 can be threadedly connected with the notch 12. so that the top cap 15 and the notch 12 are convenient to disassemble and assemble. It should be noted that the power supply device 2 can also be mounted on top of the notch 12, which is also convenient for users to operate the power supply device 2.

In Embodiment 5 of the present invention, the power supply device 2 is provided with a control switch 22 for controlling whether the power supply device 2 provides external power supply or not, so that a user can control whether the power supply device 2 provides external power supply or not through the control switch 22, and hence control whether the electronic device 3 that receives power from the power supply device 2 operates or not. The power supply battery 21 can be mounted on a power supply seat 23, the power supply seat 23 is then mounted in the notch 12, and the control switch 22 is fixed on the notch 12 and electrically connected with the power supply battery 21 through contact connection. the electronic device 3 can be selected as an illuminating lamp, the illuminating lamp can be specifically mounted on an outer side of the notch 12, and a conductive connecting piece for connecting the illuminating lamp and the power supply device 3 passes through the notch 12, so that the conductive connecting piece does not need to pass through the shaft 11; and it should be noted that the electronic device 3 can also be a radio or a Bluetooth speaker, etc.

In Embodiment 5 of the present invention, a power supply control structure of an umbrella of the present invention further comprises a trigger piece 5, wherein the trigger piece 5 is movably mounted in the runner 13 and can move up and down and be positioned relative to the runner 13; the trigger piece 5 triggers the control switch 22 (that is, turn on the control switch 22) when a distance between the trigger piece 5 and the control switch 22 reaches a trigger distance, thereby controlling the power supply device 2 to provide external power supply so that the electronic device 3 is powered to work.

In Embodiment 5 of the present invention, when opening the umbrella body 1, user moves the runner 13 together with the trigger piece 5 mounted therein upwardly until the runner 13 is positioned at an umbrella open position on the shaft 11 where the distance between the trigger piece 5 and the control switch 22 is less than or equal to the trigger distance, so that the trigger piece 5 triggers the control switch 22, and thus the control switch 22 controls the power supply device 2 to provide external power supply to operate the electronic device 3; when closing the umbrella body 1, user moves the runner 13 together with the trigger piece 5 mounted therein downwardly so that the runner 13 moves away from the umbrella open position on the shaft 11 so that the distance between the trigger piece 5 and the control switch 22 is greater than the trigger distance, and hence the trigger piece 5 will not trigger the control switch 22, and the control switch 22 will control the power supply device 2 not to provide external power supply and so the electronic device 3 will not operate; when the umbrella body 1 is in an open state, user can move the trigger piece 5 alone downwardly in the runner 13 so that the distance between the trigger piece 5 and the control switch 22 is greater than the trigger distance and hence the trigger piece 5 does not trigger the control switch 22, and the control switch 22 controls the power supply device 2 not to provide external power supply, and the electronic device 3 therefore does not operate.

It can be seen from the above that the present invention, through the arrangement of the control switch 22 and the trigger piece 5, can enable the electronic device 3 to automatically operate when the umbrella body 1 is opened and the electronic device 3 to automatically stop operating when the umbrella body 1 is closed, which is therefore convenient for users to use; in addition, when the umbrella body 1 is in an open state according to the present invention, users can also control whether the trigger piece 5 triggers the control switch 22 or not by moving the trigger piece 5 alone with respect to the runner 13, and thus control whether the power supply device 2 provides external power supply to control whether the electronic device 3 operates or not. Accordingly, user's demand for controlling the electronic device 3 when the umbrella is opened is met.

In Embodiment 5 of the present invention, the control switch 22 is a magnetic inductive switch (e.g., a magnetic reed switch), and the trigger piece 5 is a magnetic element. When the distance between the trigger piece 5 and the control switch 22 is greater than the trigger distance, a magnetic field of the trigger piece 5 will not trigger the control switch 22; and when the distance between the trigger piece 5 and the control switch 22 is less than or equal to the trigger distance, the magnetic field of the trigger piece 5 triggers the control switch 22. It should be noted that the present invention may also be embodied as follows: the control switch 22 is a tactile switch, and the trigger piece 5 may press against a key of the control switch, wherein when the distance between the trigger piece 5 and the control switch 22 is greater than the trigger distance, the trigger piece 5 does not press the key of the control switch 22 and the control switch 22 is not triggered; and when the distance between the trigger piece 5 and the control switch 22 is less than or equal to the trigger distance, the trigger piece 5 presses the key of the control switch 22 and the control switch 22 is triggered.

In Embodiment 5 of the present invention, the runner 13 is fitted with a sliding sleeve 18 slidable on the runner 13 so that the sliding sleeve 18 can slide up and down and be positioned relative to the runner 13, and the trigger piece 5 is mounted on the sliding sleeve 18 so that the trigger piece 5 can move up and down along with the sliding sleeve 18 and thus be positioned relative to the runner 13.

In Embodiment 5 of the present invention. the runner 13 is provided with a deformable part 132, and the deformable part 132 is provided with a positioning buckle 1321; the sliding sleeve 18 partially sleeves the runner 13, an inner wall of the sliding sleeve 18 is provided with a positioning part 181 corresponding to the positioning buckle 1321 of the deformable part 132, and the positioning part 181 comprises at least two positioning strips 1811 which are sequentially arranged one above another, and both of the two positioning strips 1811 are capable of being buckled by the positioning buckle 1321; according to the above arrangements, the sliding sleeve 18 can slide up and down on the runner 13, and due to the positioning buckle 1321 and the corresponding positioning strips 1811, the sliding sleeve 18 can be positioned on at least two positions of different heights on the runner 13. Specifically, the deformable part 132 of the runner 13 comprises two oppositely arranged elastic sheets 1320, and the positioning buckle 1321 is divided into two halves so that each of the two elastic sheets 1320 contains one of the two halves of the positioning buckle 1321; correspondingly, the positioning part 181 on the inner wall of the sliding sleeve 18 is also divided into two halves so as to correspond to the two halves of the positioning buckle 1321 respectively. The inner wall of the sliding sleeve 18 is also provided with a blocking portion 183; the blocking portion 183 is positioned higher than the positioning part 181; the blocking portion 183 is slidably in cooperation with the runner 13 to allow the runner 13 to be moved downwardly; specifically, when the sliding sleeve 18 slides down to a position where the blocking portion 183 abuts against the positioning buckle 1321, the runner 13 can be driven down by the sliding sleeve 18 upon continual sliding down movement of the sliding sleeve 18.

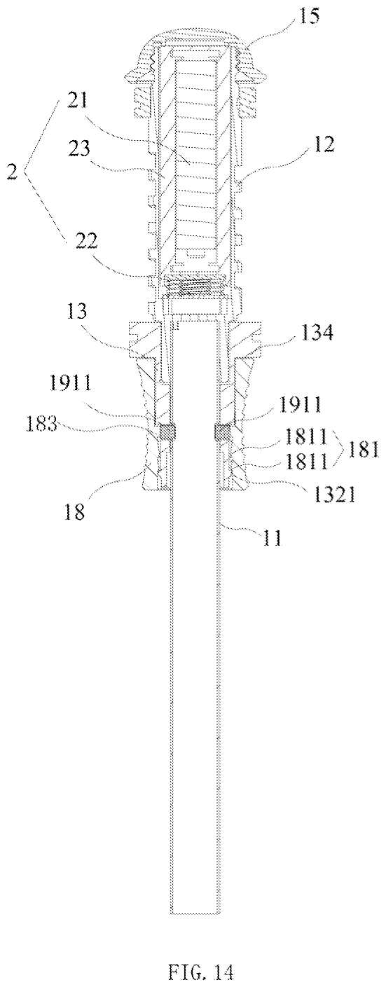

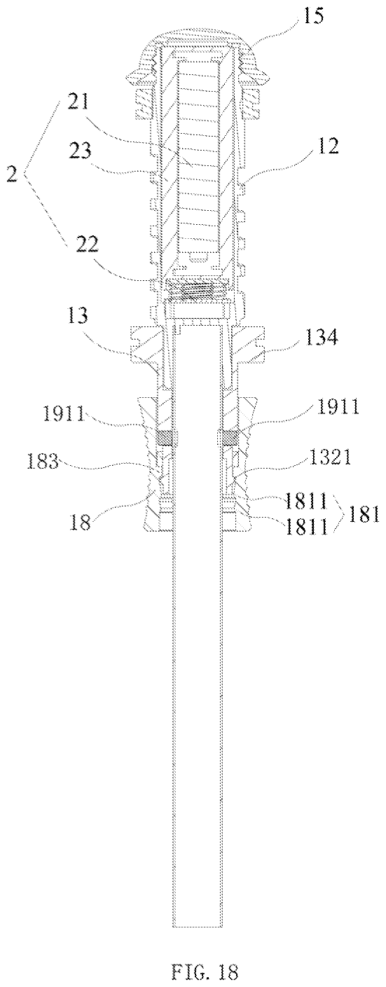

In Embodiment 5 of the present invention, the runner 13 is also fitted with a buckling component 19 for buckling with the shaft 11 of the umbrella body 1, so that the runner 13 can be positioned at said umbrella open position on the shaft 11 when the umbrella body 1 is opened, Specifically, the runner 13 is provided with two oppositely arranged through holes 133, and the shaft 11 is provided with two buckling holes 111 corresponding to the through holes 133 of the runner 13 respectively; the buckling component 19 comprises two oppositely arranged !Duckling pieces 191 which are provided with buckling blocks 1911 respectively, the buckling blocks 1911 of the two buckling pieces 191 pass through the two through holes 133 of the runner 13 respectively towards a center of the runner 13, and then buckle with the two buckling holes 111 of the shaft 11 respectively; the sliding sleeve 18 partially sleeves the runner 13 and entirely sleeves the two buckling pieces 191, the inner wall of the sliding sleeve 18 is also provided with a pushing part 182 for driving the two buckling pieces 191 to move towards a direction away from the center of the runner, the pushing part 182 comprises two oppositely arranged pushing blocks 1821, and two sides of each of the pushing blocks 1821 are provided with pushing inclined surfaces 1822 respectively: the two pushing blocks 1821 are removably inserted into two gaps formed between the two buckling pieces 191 respectively. As shown in FIGS. 14-17, no matter if the positioning buckle 1321 is buckled to the upper positioning strip or the lower positioning strip, the two pushing blocks 1821 of the sliding sleeve 18 are still disengaged from the two gaps formed between the two buckling pieces 191. As shown in FIGS. 18-21, when the blocking portion 183 of the sliding sleeve 18 abuts against the positioning buckle 1321, the two pushing blocks 1821 of the sliding sleeve 18 will be inserted into the two gaps formed between the two buckling pieces 191 respectively.

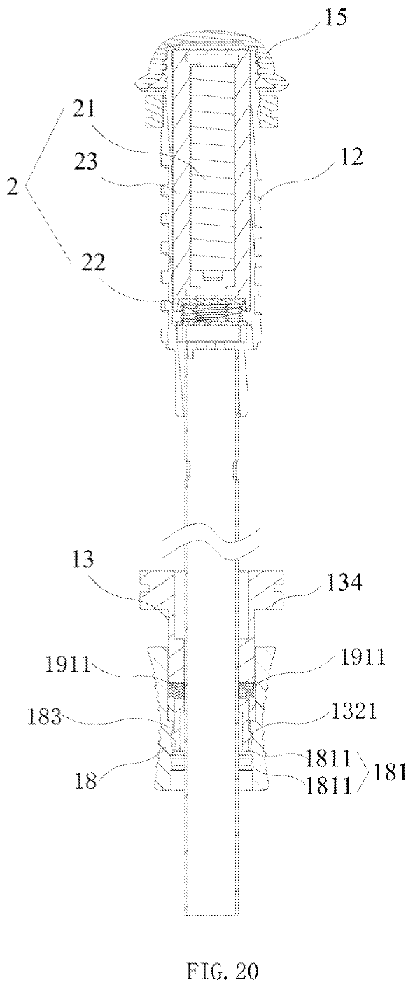

According to the present invention, when opening the umbrella, slide the sliding sleeve 18 upwardly on the runner 13 until the two pushing blocks 1821 are disengaged with the two buckling pieces 191 (that is to say, the two pushing blocks 1821 are disengaged from the two gaps formed between the two buckling pieces 191, as shown in FIG. 20), then continue moving the sliding sleeve 18 upwardly so that the runner 13 is also driven to move upwardly until the runner 13 reaches the umbrella open position where the buckling blocks 1911 of the two buckling pieces 191 buckle with the two buckling holes 111 of the shaft 11 respectively to maintain the umbrella body 1 in an open state (as shown in FIGS. 14-17, and 22); As shown in FIGS. 18-21, when closing the umbrella, slide the sliding sleeve downwardly on the runner 13 until the blocking portion 183 abuts against the positioning buckle 1321. and the two pushing blocks 1821 are inserted into the two gaps formed between the two buckling pieces 191, and as such, the two buckling pieces 191 are pressed to move away from the center of the runner so that the buckling blocks 1911 of the two buckling pieces 191 are disengaged from the two buckling holes 111 of the shaft 11, and then continue moving the sliding sleeve 18 downwardly so that the runner 13 is also driven to move downward until the runner 13 moves a position where the umbrella is closed. The runner 13 can be provided with a limiting part 134 to allow abutment of a top of the sliding sleeve 18 to ensure that the sliding sleeve 18 can stably drive the runner 13 to move upwardly.

In Embodiment 5 of the present invention, two ends of each of the buckling pieces 191 are provided with inclined surfaces 1912 corresponding to the corresponding pushing inclined surfaces 1822 so that the two pushing blocks 1821 can be smoothly inserted into the two gaps formed between the two buckling pieces 191. In addition, an outer wall of the runner 13 is provided with a slot 135 for inserting the two buckling pieces 191 in order to reduce the size of the present invention.

The above embodiments and drawings are not intended to limit the form and types of the product of the present invention, and any suitable changes or modifications made by those of ordinary skill in the art shall fall within the patent scope of the present invention.

What is claimed is:

1. A power supply control structure of an umbrella, comprising an umbrella body and a power supply device for supplying power,
wherein the umbrella body comprises a shaft, a notch arranged at an upper end of the shaft, a runner movably sleeving the shaft, and a rib assembly hinged to the notch and the runner;
the power supply device is arranged on an upper part of the umbrella body; the power supply device comprises a power supply battery.

2. The power supply control structure of claim 1, wherein the power supply device is mounted in, the notch; or
the power supply device is mounted on the rib assembly; or
the power supply device is mounted on an upper part of the shaft and above the runner.

3. The power supply control structure of claim 1, wherein the power supply device is provided with a control switch configured to control whether the power supply device provides external power supply or not.

4. The power supply control structure of claim 3, wherein the runner controls whether the control switch is on or off.

5. The power supply control structure of claim 4, wherein the control switch is an inductive switch, and the runner is provided with an inductive piece configured to control whether the inductive switch is on or off.

6. The power supply control structure of claim 4, wherein the control switch is a tactile switch, and the runner presses against the tactile switch or released from pressing the tactile switch to control whether the tactile switch is on or off.

7. The power supply control structure of claim 3, further comprising a trigger piece, wherein the trigger piece is movably mounted in the runner and movable up and down and be positioned relative to the runner; the trigger piece turns on the control switch when a distance between the trigger piece and the control switch reaches a trigger distance, thereby controlling the power supply device to provide external power supply.

8. The power supply control structure of claim 7, wherein the runner is provided with two oppositely arranged through holes, and the shaft is provided with two buckling holes corresponding to the through holes of the runner respectively;
the runner is also fitted with a buckling component configured to buckle with the shaft of the umbrella body; the buckling component comprises two oppositely arranged buckling pieces which are provided with buckling blocks respectively, the buckling blocks of the two buckling pieces pass through the two through holes of the runner respectively towards a center of the runner, and removably buckle with the two buckling holes of the shaft respectively;
the runner is fitted with a sliding sleeve slidable up and down on the runner and being positioned relatively to the runner; the sliding sleeve partially sleeves the runner and entirely sleeves the two buckling pieces; an inner wall of the sliding sleeve is also provided with a pushing part configured to drive the two buckling pieces to move towards a direction away from the center of the runner;
the trigger piece is mounted in the runner.

9. The power supply control structure of claim 7, wherein the control switch is a magnetic inductive switch, and the trigger piece is a magnetic element.

10. The power supply control structure of claim 7, wherein the control switch is a tactile switch, and the trigger piece is configured to press a key of the control switch or released from pressing the key of the control switch.

11. The power supply control structure of claim 3, wherein the control switch is a remote control switch, and the remote control switch is controlled by a remote controller.

12. The power supply control structure of claim 3, wherein the control switch is a tactile switch or a self-locking switch.
